(19) United States
(12) Patent Application Publication
(10) Pub. No.: US 2025/0069130 A1
(43) Pub. Date: Feb. 27, 2025

(54) PRODUCT BUNDLING SYSTEMS AND METHODS

(71) Applicant: ROYAL BANK OF CANADA, Toronto (CA)

(72) Inventors: Aidan Mann Rong LI, Toronto (CA); Luke David CHESELDINE, Toronto (CA); Youyi DENG, Toronto (CA); Kieran Julian MCSWEENEY, Toronto (CA); Prash RASAIAH, Toronto (CA); Pravin Anthony RODRIGUES, Toronto (CA); Devesh SINGH, Toronto (CA)

(21) Appl. No.: 18/812,236

(22) Filed: Aug. 22, 2024

Related U.S. Application Data
(60) Provisional application No. 63/534,202, filed on Aug. 23, 2023.

(51) Int. Cl. G06Q 30/0601

(52) U.S. Cl. CPC G06Q 30/0631

(57) ABSTRACT

Product bundles for sale together can be generated by determining one or more anchor products from sales and inventory data, and using a recommendation model to determine products to bundle with the anchor products. The possible bundles can be presented to a merchant and posted to an online sales channel.

### RELATED APPLICATIONS

The current application claims priority to U.S. Provisional Application 63/534,202 filed Aug. 23, 2023, the entire contents of which are incorporated herein by reference for all purposes.

### TECHNICAL FIELD

The current disclosure relates to systems and methods for product sales, and in particular to systems and methods for determining products to be bundled together for sale.

### BACKGROUND

Driving product sales in an online environment is important for businesses. One strategy for increasing sales is recommending products to a user. Products to recommend for a particular user can be determined using a recommendation model that has been trained on information about various users and products purchased by the users. Another strategy for increasing sales is product bundling in which items are grouped together that may increase the sale of one or more of the bundled products. Making good, sensible bundles that a consumer is more likely to buy can help sales for a merchant's business. However, determining what items are sensible to bundle together is a time consuming process. Further, determining product bundle can be difficult for business owners that may not have expertise in the area or sufficient sales information for products to determine sensible product bundles.

A new, additional, alternative and/or improved system and method for determining product bundles for a merchant is desirable.

### BRIEF DESCRIPTION OF THE DRAWINGS

Further features and advantages of the present disclosure will become apparent from the following detailed description, taken in combination with the appended drawings, in which:

FIG. 1 depicts a system for determining product bundles for offer by a merchant;

FIG. 2 depicts a method for determining product bundles for offer by a merchant;

FIG. 3 depicts a process for training a recommendation model for use in determining product bundles;

FIG. 4 depicts a method for training a model and using the trained model to provide a product bundle;

FIG. 5 depicts a process for a merchant to offer product bundles for sale; and

FIG. 6 depicts a user interface for use by a merchant to offer product bundles for sale.

### DETAILED DESCRIPTION

In accordance with the present disclosure, there is provided a computer implemented method of providing products for sale in an online store, the method comprising: training a recommendation model on product sales information; identifying at least one anchor product using one or more of the product sales information and product inventory data; for each of the at least one anchor products, applying the respective anchor product to the trained model to identify at least one product recommended for sale with the respective anchor product in a respective product bundle; generating a user interface to present the at least one product bundles to a merchant; receiving an indication of one or more of the product bundles selected to offer for sale on an online sales channel; and posting the selected one or more product bundles to the online sales channel.

In a further embodiment of the method, identifying the at least one anchor product is based on inventory data.

In a further embodiment of the method, identifying the at least one anchor product uses a turnover ratio for each product.

In a further embodiment of the method, the identified at least one anchor product comprise one or more of: products having a highest turnover ratio; and products having a lowest turnover ratio.

In a further embodiment of the method, the turnover ratio for a product is determined by: determining an average stock level of the product over a time period; determine a cost of goods for the product by multiplying a merchant's product cost by a total number of the products sold over the time period; and determining the product's turnover ratio by dividing the cost of goods by the average stock level.

In a further embodiment of the method, the at least one anchor product is identified as a popular or unpopular product.

In a further embodiment of the method, a popularity of the at least one anchor product is determined for first-time customers and returning customers.

In a further embodiment of the method, the recommendation model comprises a graph neural network (GNN).

In a further embodiment of the method, training the recommendation model comprises: generating a graph from the product sales information with nodes of the graph representing products and edges of the graph between nodes representing products represented by the nodes having been sold in a single order; and training the GNN using the generated graph.

In a further embodiment of the method, the method further comprises: receiving recent product sales information; and updating the graph using recent product sales information.

In a further embodiment of the method, applying the respective anchor product to the trained model comprises: providing a tensor of edge indices of the updated graph; providing a tensor of edge weights; a tensor of one or more node indices of the one or more anchor products; and a parameter indicating a number of recommended products to provide.

In a further embodiment of the method, training the recommendation model comprises learning product embeddings.

In accordance with the present disclosure, there is further provided a system providing products for sale in an online store, the system comprising: at least one processor; and at least one memory storing instructions which when executed by the at least one processor configure the system to provide a method according to any of the methods above.

In accordance with the present disclosure, there is further provided a non-transitory computer readable memory storing instructions which when executed by at least one processor provide a method according to any of the methods above.

As described further below, product bundles can be automatically determined for a merchant based on sales and product inventory information. An anchor product for a bundle is automatically determined and used to determine one or more additional products that can be bundled together, in order to increase sales. The additional products for bundling are determined using a recommendation model, which can be for example a graph neural network (GNN). The product bundles can be automatically or, semi-automatically, posted to one or more online sales channels The product bundling systems and methods described herein allow a merchant to create sensible product bundles, even if the merchant does not have expertise to determine sensible bundles.

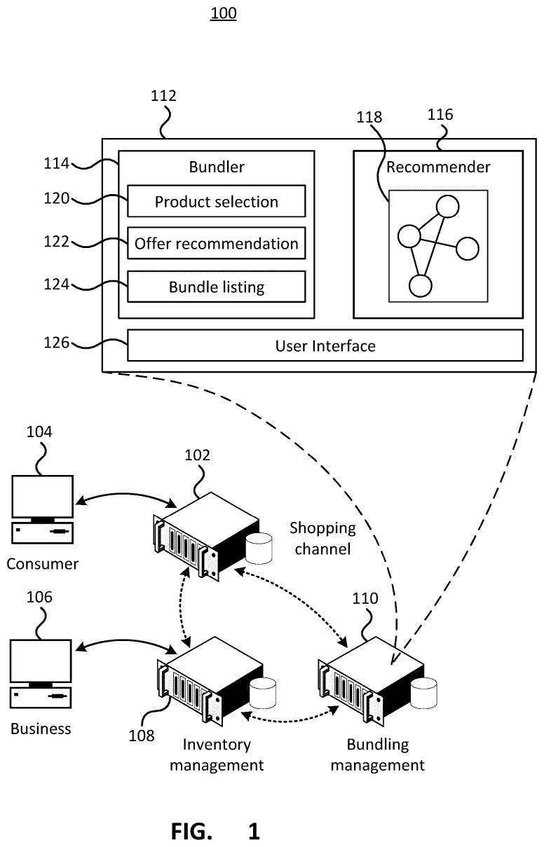

FIG. 1 depicts a system for determining product bundles for offer by a merchant. The system 100 uses a recommendation model that can recommend products to bundle with a given product, referred to as an anchor product. The anchor product or products can be identified through data analysis on inventory data, and possibly sales data, of the business, or of groups of businesses. The anchor products may be key business products, products that are essential to the business, products that are selling well and so could be leveraged to increase sales of other products, products that are not selling well and so could benefit from being bundled with other products, products that have high inventory levels, etc. The anchor products can be provided to the recommendation model to determine possible products to bundle with the anchor product. Possible product bundles can be presented to the business and one or more of the bundles selected for posting to a sales channel, such as one or more online sales platforms and/or rewards platforms. The system provides a user interface that enables a user to easily see inventory and sales information, key products, potential bundles for them, and options to list product campaigns on sales and/or rewards channels.

As depicted in FIG. 1, the system 100 may comprise a number of interacting computing devices including one or more servers providing online shopping and/or rewards platforms 102. The online shopping platforms may be accessed by one or more consumers through computer devices, which may include for example, personal computers, laptop computers, smartphone devices, and/or other computing devices. One or more businesses may offer products and/or services on the online shopping platforms. The business or business representative may use a computing device 106 to access an inventory management system 108 that allows the business to enter their product inventory information and can interface with the online shopping channel(s) 102 in order to offer products for sale. The online shopping platforms 102 may interface with the inventory management system 108 in order to maintain update to product inventory information as well as provide other information to the business, such as sales information of the products sold, user information of the users purchasing products, etc. A bundling server 110 may access inventory and sales information from possibly the inventory management system 108 and/or the sales platform 102 in order to determine one or more product bundles that may be offered by the business. The bundling server 110 may access the online shopping platforms in order to post, or otherwise make available, a product bundle to the shopping platform for the business.

The bundling server 110 provides various functionality 112 for determining sensible product bundles. The functionality 112 includes a bundler 114, or bundling functionality, and a recommender 116, or recommendation functionality. The recommender 116 comprises a trained recommendation model 118 that, given a particular product, can recommend one or more products to bundle with it. The model 118 may be implemented using various existing recommendation models such as content filtering based recommendation model, a context filtering based recommendation model, a collaborative filtering based recommendation model, a hybrid recommendation model, sequential self-attention/contrastive self-supervised learning models based on the transformers architecture. While the recommendation model 118 may use existing recommendation models, in contrast to typical recommendation models which recommend a product to a user, the recommendation model 118 recommends a product for a product.

The bundler 114 determines one or more products, referred to as an anchor product, to provide to the recommender 116. The bundler 114 includes product selection functionality 120 that selects one or more anchor products for a business to include in possible bundles. The product selection functionality 120 may provide the selected products to the recommender and form one or more bundles based on the products identified by the recommender 116. For each of the anchor products, one or more products identified by the recommender 116 can be selected for inclusion in the bundle, for example the top selling products from the recommended products can be selected, or the worst selling products may be included. How well a product sells may be determined in various ways including for example based on an inventory turnover ratio, total sales, value of sales, etc. The selection of recommended products may be further based on seasonal products, products for loyal customers, or other considerations that allow one or more of the recommended products to be selected as a sensible bundling with the anchor product. The potential bundles provided by the anchor product and one or more recommended products can be provided to offer recommendation functionality 122 that can determine one or more possible offers to provide with the bundle, such as offering one or more of the products at a particular discount. Bundle listing functionality 124 can receive one or more of the product bundles, and possibly offers for the bundles, and list the product bundle to one or more sales channels.

The bundling functionality 112 may include user interface functionality 126 that can provide a user interface to the business to interact with the bundling functionality. The user interface may allow the business to, for example, select one or more products for further bundling, identify potential offers and select the bundles and sales channels for posting the bundles to.

The bundling functionality 112 may use a recommendation system that is trained to learn product embeddings, and then can be used to recommend products to bundle with a particular product. The particular product can be identified through data processing and analysis to identify key products based on various metrics, including for example a turnover ratio metric. The bundling functionality 112 can provide a user interface or dashboard where the business user can easily see key products, potential bundles for these products, and options to list products and product bundles to online sales channels.

The system 100 helps small business owners, including small business owners drive sales and gain new customers. The system provides a recommendation engine to identify products that customers are likely to buy together with a given product. The particular product, or products, for use in bundling can be determined through data analysis on inventory data, and possibly sales information. The system can provide a dashboard user interface to display relevant product-level data analysis and recommendations. It creates a new straightforward, streamlined process to list product campaigns on different shopping channels.

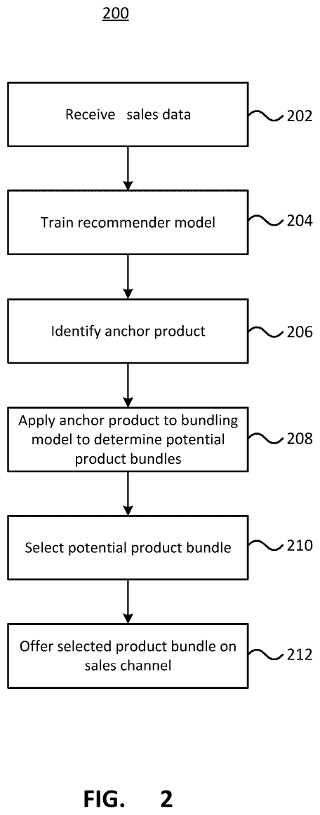

FIG. 2 depicts a method for determining product bundles for offer by a merchant. The method 200 begins with receiving sales data (202). The sales data may provide information about sales of products including what products have been ordered together. The sales data may be for an individual business or may be aggregated from a plurality of businesses. The sales data may comprise, for example order information indicating products purchased along with costs, and date/time of the transaction. In addition to the sales data, inventory information may be received providing information about products, including inventory levels and costs of the goods for the business. The sales data, and possibly the inventory information, is used to train a recommender model (204). The model may use various different architectures, including for example a Graph Neural Network (GNN) architecture. Other recommendation models may be based on matrix factorization, various deep learning or neural network models such as neural collaborative filtering, as well as autoencoders. Our solution uses graph neural networks, which is a kind of Deep Learning model

When using a GNN based recommender, in order to train a GNN, the sales data, and possibly the inventory data, is processed to create a graph with nodes representing products and edges between two product nodes providing an indication that the two products were sold together. The weight of the edges may represent the number of times the two products represented by the nodes have been sold together. The weights may be determined based on sales over a period of time, such as the last year, months, month, week, etc. Further, the edge weightings may be further weighted based on the recency of sales so that sales that occurred more recently are considered more relevant. Once trained, the model is used to recommend products to be sold together in a product bundle. One or more anchor products are identified (206) that are considered for bundling. The anchor products may be identified based on various factors, including for example, inventory levels, carrying costs, age of inventory of products, a turnover ratio of the products, etc. For example, an anchor product may be a product that sells well and as such may be leveraged for the sale of additional products. Additionally or alternatively, an anchor product may be a product that has not sold well and as such could benefit from being bundled with other products. Once an anchor product is identified is provided to, or applied to, the trained model in order to determine one or more potential products to bundle with the anchor product (208). The product bundles, namely an anchor product and one or more recommended products, can be presented to a business owner or representative. One or more of the product bundles can be selected (210) and the selected product bundle or bundles provided to or poste to an online sales channel (212). In addition to presenting the product bundles to the business, it is possible to provide one or more possible offers for the bundle such as a percentage off, or price to offer the products/bundles at. The determination of the offer may be determined based on the inventory and/or sales information as well as other information including possibly an expected performance of the bundling.

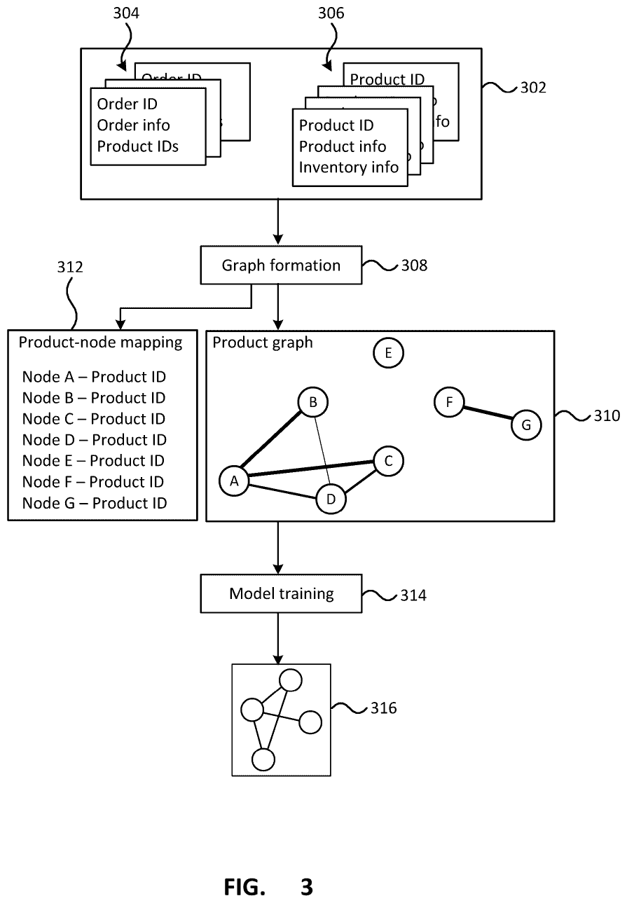

FIG. 3 depicts a process for training a recommendation model for use in determining product bundles. The bundling process described above can use any type of recommender model. As described further below, a particular model may be a Graph Neural Network (GNN). The Graph neural networks are state-of-the-art for collaborative filtering and are well suited for recommendation problems, since most data for recommendation-style problems can be represented as a graph. The graphs can capture relationships between entities very well, including products that have been sold together. GNNs have a superior ability to learn on graph-structured data compared to other model architectures such as transformer-based models. GNNs have the ability to capture relationships between neighbours of neighbours, neighbours of neighbours of neighbours, etc. Using a graph neural network yields significant improvements in accuracy, precision@K and recall@K. Essentially, the products recommended by the GNN for bundling are more likely to be bought together than products recommended for bundling by other methods, such as matrix factorization. The GNN may use various different architectures including models based on a graph convolutional network (GCN) model architecture described in “Semi-Supervised Classification with Graph Convolutional Networks” Kipf, T. N., & Welling, M. (2016), the entire contents of which are incorporated herein by reference in its entirety for all purposes. The GCN model may be implemented in various ways including using LightGCN described in in “Lightgcn: Simplifying and powering graph convolution network for recommendation” In Proceedings of the 43rd International ACM SIGIR conference on research and development in Information Retrieval (pp. 639-648), by Deng et al., the entire contents of which are incorporated herein by reference in its entirety for all purposes. The trained graph neural network identifies products that are most likely to be bought together with a given product. Given a product id as input, and a maximum bundle size, the model identifies a maximum bundle size number of potential products that can be bundled with the input product.

In training the model, data 302 may be provided by one or more businesses. The business data 302 may be specific to individual businesses, or may be aggregated across multiple businesses. The business data 302 may comprise order or sales information 304 that provides an indication of orders that were placed and may include information such as an order ID, order date, time, location etc., products that were purchased, cost of the products, etc. In addition to the order information 304, the business data 302 may also include product information 306. The product information may comprise inventory information for a business and may include product identifications, product information, inventory information, product cost for the business as well as other product data. The business data 302, or possibly just the order information 304, is passed to graph formation functionality 308 that processes the data to generate a product graph 310. The product graph comprises nodes representing products and edges connecting nodes together if the products represented by the nodes were purchased together. The weight of the edges may be representative of the strength of the relationship between the nodes. For example, the edge weight may increase based on the number of times the two products have been purchased together. In addition to the graph, mapping may be generated during the graph formation that provides a mapping between the graph nodes and the particular products. Once the graph is generated, it may be used to train the model by model training functionality 314. The graph 310, or an adjacency matrix representation of the graph may be used for training. A mask be applied to the adjacency matrix so that only the edges in the lower diagonal region is used for training. The model training functionality 314 generates a trained model 316. The model 316 may be iteratively generated by the training process.

In the training process, a batch of edge indices, and a tensor of positive and negative edges are provided and the model is used to generate predicted positive and negative ranks for the edges. In this context, a positive edge is an edge that exists in the graph 310. A negative edge is an edge that does not exist in the graph 310. The positive and negative edges each have the same starting node, which is the product ID stored at the index supplied from the batch. The positive and negative ranks generated are given as inputs to the loss function, which can be a Bayesian Personalized Ranking loss function. The optimizer can be an Adam optimizer with learning rate of for example 0.001. The training may use iterative gradient descent using the optimizer based on the loss function. It will be appreciated that various training techniques may be applied to generate the trained model. For the GNN model, the training process attempts to learn product embeddings for the graph.

As described above, the input data is transformed into a graph representation for GNN training. Unique products are allocated as nodes, and edges represent relationships between products. Products have appropriate edge weights that have been normalized with stronger weights indicating a stronger purchasing relationship between products (i.e. they were bought together in more orders). The resulting graph structure captures the purchasing relationships between products. The GNN may have 2 graph convolutional layers that perform message passing and feature aggregation. Although described as using 2 convolutional layers, it is possible to include additional layers. The GNN iteratively passes messages between connected nodes to propagate information throughout the graph. At each layer, nodes aggregate and combine features from their neighbours using an aggregation function. For the LightGCN model architecture described above, the normalized sum of neighbour embeddings is used as the aggregation function.

The product graph 310 may be updated periodically to reflect the most recent sales information. For example, the product graph may be updated hourly, weekly, monthly, etc. The product graph 310 may only include information for a particular length of time, such as the past month, 6 months, year, etc. The model 316 may also be periodically trained, re-trained, or tuned based on the updated product graph, however the training/re-training/tuning of the model does not need to be performed as frequently as the graph update.

The model 316 may include a recommendation function that generates the recommendations once the model is trained. The model inputs are a tensor of edge indices of the product graph, a tensor of corresponding edge weights, a tensor representing the node indices for which recommendations are to be generated, and a parameter k indicating the number of recommendations to be generated. The model outputs a tensor where k nodes are recommended for each of the node indices in the input.

The recommendation function of the graph neural network can take in an adjacency matrix in edge index format that represents the graph structure. It contains the connections/edges between nodes. The recommendations are generated based on the relationships defined by this adjacency matrix. During training, the GNN learns node embeddings. The node embeddings do not retain information such as which nodes a particular node is connected to or how many neighbours it has, although the GNN can learn and leverage the information in training.

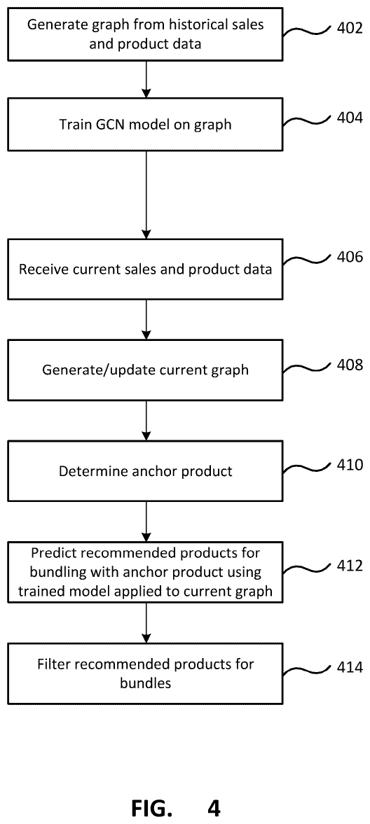

FIG. 4 depicts a method for training a model and using the trained model to provide a product bundle. The method 400 begins with generating a product graph from historical sales data (402). Depending on the information included in the nodes, the product graph may be generated based on the product data. The product graph may be generated as described above, by adding nodes for each of the products of an order that are not already included in the graph. Once the product nodes are added, the weights of edges connecting nodes of products that are purchased to together are updated to reflect the strength of the relationship between the two products. The generated graph is used to train a GNN, which may be a graph convolutional network (GCN), model (404).

After training the model, current sales and product data may be received (406) and used to generate a current product graph (408). The current product graph may be generated by updating the initial product graph generated from the historical data. The product data may include inventory levels, which may be included in the product graph, or may be stored separately from the graph. Anchor product can be determined from the product data (410) and used with the trained GCN model to predict which products should be recommended for bundling with the anchor product (412). The GCN may provide the top number of products for recommendation. The recommended products for each anchor product can be filtered (414) in order to provide only the top, or possibly worst, performing products in the bundles. The selection of the best/worst products to bundle may be determined based in part on how the anchor products were selected. For example, if the anchor product was selected as the best selling product, the products to bundle with it may be selected from the worst performing recommended products. Similarly, if the anchor product was selected as the worst selling product, the products to bundle with it may be selected from the best performing recommended products. The performance of the products may be based on various metrics including sales, turnover, cost of goods, etc.

In determining the anchor products, the product and sales data may be processed. To identify anchor products, the inventory data, which may be collected hourly over a time window, such as the last 30 days, can be analyzed. The time window, as well as the updating frequency of the inventory data can vary. The time series of the inventory data may be analyzed and used to construct a turnover ratio metric for each product. The turnover ratio may be used as the metric for the best and worst selling products. The turnover ratio may be determined by determining the total product cost of the specific product sold over the time window by multiplying the product cost to the business, not the retail cost to consumers, by the total number of the product sold over the time window. The total product cost is then divided by the average inventory of the product over the time window. The anchor products may be identified as the best-selling product, or products, and/or as the worst selling product or products. The anchor products are provided to the trained model to generate the top number of product bundling recommendations.

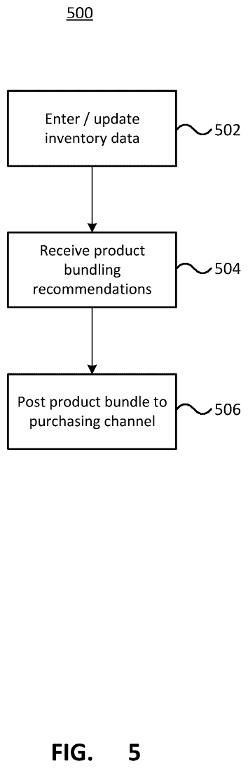

FIG. 5 depicts a process for a merchant to offer product bundles for sale. The process 500 begins with inputting and/or updating inventory and sales data (502). The data may be manually entered, or may be obtained programmatically from existing sources such as an inventory management system. The inventory data can be automatically processed in order to receive product bundling recommendations (504) as described above. Once the product bundling recommendations are reviewed, one or more of the recommendations may be posted to an online sales channel (506).

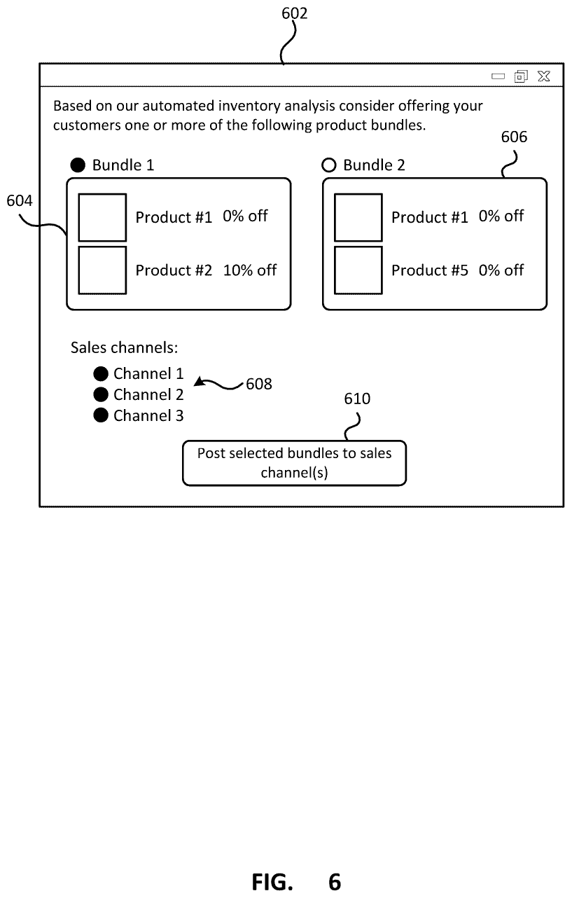

FIG. 6 depicts a user interface for use by a merchant to offer product bundles for sale. The user interface 602 depicted in FIG. 6 is only illustrative of possible graphical arrangements that can be presented to the user and similar functionality can be provided in different graphical arrangements and interactions. The user interface 602 may be presented to the user after the user has entered product information into the system and product bundlings determined, which may occur automatically, or as a result of a user's action such as clicking a button to generate new bundlings. The user interface 602 may present the user with a plurality of product bundlings 604, 606 that were determined for the business. The product bundlings may be presented to the user including information about the products included in the bundlings as well as possible offerings determined for the products in the bundle or the bundle as a whole. As depicted in one bundle 604, it is suggested that product number 2 is offered at a 10% discount when purchased as part of the suggested bundle. For the second bundle 606, no discount is suggested to be provided. It will be appreciated that the business may change the offers, such as a discount amount, for the bundles. One or more of the bundles may be selected. Product bundle 604 is selected as depicted by the black filled circle, while product bundle 606 is not selected as depicted by the unfilled circle. In addition to selecting one or more of the bundles 604, 606, the user interface may also provide one or more sales channels for selection 608 that the selected product bundles will be posted to. The user interface includes a button 610 that causes the selected bundles to be posted to the selected sales channels.

The above has described a product bundling system that allows businesses to automatically determine sensible product bundlings to increase potential sales. The bundling process uses a recommender model trained on historical sales data in order to recommend products to bundle together based on what products have been purchased together in the past. In order to suggest product bundles to a business, the bundling functionality processes inventory and sales data for a business in order to identify one or more key or anchor products that will be included in respective bundles. The determined anchor products are then provided to the trained recommendation model to determine one or more potential sensible bundling products. The possible product bundles can then be presented to the business and posted to one or more sales channels. The bundling process may be completed automated, from retrieving sales and product data to the selection of key products and bundling recommendations as well as the posting to sales channels. Additionally or alternatively, the process may involve user actions such as selecting bundles for posting, adjusting offers on the product bundles etc. Regardless, the system and methods described above provide an easy, convenient and efficient means for a business to provide sensible product bundles to potentially increase sales, even if the business does not have expertise in determining which products could or should be bundled together.

It will be appreciated by one of ordinary skill in the art that the system and components shown in FIGS. 1-6 can include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

Although certain components and steps have been described, it is contemplated that individually described components, as well as steps, can be combined together into fewer components or steps or the steps can be performed sequentially, non-sequentially or concurrently. Further, although described above as occurring in a particular order, one of ordinary skill in the art having regard to the current teachings will appreciate that the particular order of certain steps relative to other steps can be changed. Similarly, individual components or steps can be provided by a plurality of components or steps. One of ordinary skill in the art having regard to the current teachings will appreciate that the components and processes described herein can be provided by various combinations of software, firmware and/or hardware, other than the specific implementations described herein as illustrative examples.

The techniques of various embodiments can be implemented using software, hardware and/or a combination of software and hardware. Various embodiments are directed to apparatus, e.g. a node which can be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more or all of the steps of the described method or methods.

Some embodiments are directed to a computer program product comprising a computer-readable medium comprising code for causing a computer, or multiple computers, to implement various functions, steps, acts and/or operations, e.g. one or more or all of the steps described above. Depending on the embodiment, the computer program product can, and sometimes does, include different code for each step to be performed. Thus, the computer program product may, and sometimes does, include code for each individual step of a method, e.g., a method of operating a communications device, e.g., a wireless terminal or node. The code can be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the method(s) described herein. The processor can be for use in, e.g., a communications device or other device described in the present application.

Numerous additional variations on the methods and apparatus of the various embodiments described above will be apparent to those skilled in the art in view of the above description. Such variations are to be considered within the scope.

What is claimed is:

1. A computer implemented method of providing products for sale in an online store, the method comprising:
training a recommendation model on product sales information;
identifying at least one anchor product using one or more of the product sales information and product inventory data;
for each of the at least one anchor products, applying the respective anchor product to the trained model to identify at least one product recommended for sale with the respective anchor product in a respective product bundle;
generating a user interface to present the at least one product bundles to a merchant;
receiving an indication of one or more of the product bundles selected to offer for sale on an online sales channel; and
posting the selected one or more product bundles to the online sales channel.

2. The method of claim 1, wherein identifying the at least one anchor product is based on inventory data.

3. The method of claim 2, wherein identifying the at least one anchor product uses a turnover ratio for each product.

4. The method of claim 3, wherein the identified at least one anchor product comprise one or more of:
products having a highest turnover ratio; and
products having a lowest turnover ratio.

5. The method of claim 4, wherein the turnover ratio for a product is determined by:
determining an average stock level of the product over a time period;
determine a cost of goods for the product by multiplying a merchant's product cost by a total number of the products sold over the time period; and
determining the product's turnover ratio by dividing the cost of goods by the average stock level.

6. The method of claim 2, wherein the at least one anchor product is identified as a popular or unpopular product.

7. The method of claim 6, wherein a popularity of the at least one anchor product is determined for first-time customers and returning customers.

8. The method of claim 1, wherein the recommendation model comprises a graph neural network (GNN).

9. The method of claim 8, wherein training the recommendation model comprises:
generating a graph from the product sales information with nodes of the graph representing products and edges of the graph between nodes representing products represented by the nodes having been sold in a single order; and
training the GNN using the generated graph.

10. The method of claim 9, further comprising:
receiving recent product sales information; and
updating the graph using recent product sales information.

11. The method of claim 10, wherein applying the respective anchor product to the trained model comprises:
providing a tensor of edge indices of the updated graph;
providing a tensor of edge weights;
a tensor of one or more node indices of the one or more anchor products; and
a parameter indicating a number of recommended products to provide.

12. The method of claim 1, wherein training the recommendation model comprises learning product embeddings.

13. A system providing products for sale in an online store, the system comprising:
at least one processor; and
at least one memory storing instructions which when executed by the at least one processor configure the system to provide a method comprising:
training a recommendation model on product sales information;
identifying at least one anchor product using one or more of the product sales information and product inventory data;
for each of the at least one anchor products, applying the respective anchor product to the trained model to identify at least one product recommended for sale with the respective anchor product in a respective product bundle;
generating a user interface to present the at least one product bundles to a merchant;
receiving an indication of one or more of the product bundles selected to offer for sale on an online sales channel; and
posting the selected one or more product bundles to the online sales channel.

14. The system of claim 13, wherein identifying the at least one anchor product is based on inventory data.

15. The system of claim 14, wherein identifying the at least one anchor product uses a turnover ratio for each product.

16. The system of claim 15, wherein the identified at least one anchor product comprise one or more of:
products having a highest turnover ratio; and
products having a lowest turnover ratio.

17. A non-transitory computer readable memory storing instructions which when executed by at least one processor provide a method comprising:
training a recommendation model on product sales information;
identifying at least one anchor product using one or more of the product sales information and product inventory data;
for each of the at least one anchor products, applying the respective anchor product to the trained model to identify at least one product recommended for sale with the respective anchor product in a respective product bundle;
generating a user interface to present the at least one product bundles to a merchant;
receiving an indication of one or more of the product bundles selected to offer for sale on an online sales channel; and
posting the selected one or more product bundles to the online sales channel.

18. The non-transitory computer readable memory of claim 17, wherein identifying the at least one anchor product is based on inventory data.

19. The non-transitory computer readable memory of claim 18, wherein identifying the at least one anchor product uses a turnover ratio for each product.

20. The non-transitory computer readable memory of claim 19, wherein the identified at least one anchor product comprise one or more of:
products having a highest turnover ratio; and
products having a lowest turnover ratio.
